(19) United States
(12) Patent Application Publication
(10) Pub. No.: US 2003/0100264 A1
(43) Pub. Date: May 29, 2003

(54) Wireless computer monitor

(76) Inventor: Daryl Dean Schroeder, Florissant, CO (US)

Correspondence Address: HEWLETT-PACKARD COMPANY, Intellectual Property Administration, P.O. Box 272400, Fort Collins, CO, 80527-2400, US

(21) Appl. No.: 09/994,634

(22) Filed: Nov. 28, 2001

(51) Int. Cl. H04B 7/00

(52) U.S. Cl. 455/66; 455/575

(57) ABSTRACT

A computer system includes a computer wireless transceiver capable of relaying wireless communications to and from a computer main unit, a computer display device, and a monitor wireless transceiver connected to the computer display device. The monitor wireless transceiver conducts wireless communications with the computer wireless transceiver. The monitor wireless transceiver and the computer display device form a wireless computer monitor that receives data from and transmits data to the computer main unit in a wireless manner.

### FIELD OF THE INVENTION

The present invention relates generally to a computer system, and more particularly to a computer system including a wireless computer monitor.

### BACKGROUND OF THE INVENTION

Computers play an important part in modern communications and data manipulation. Computers are widely used for many types of text processing, record keeping, electronic communications, design and automation, etc. Such applications may include the display of text, graphics, animations, videos, etc. Therefore, one of the important components of a computer system is a display, commonly referred to as a computer monitor. Because humans are highly visual and absorb information mainly through visual means, the computer monitor consequently is an important part of a computer system.

The computer monitor may be connected to a personal computer, a computer work station, or may comprise a dumb network terminal. The computer sends electronic information to the monitor, and the monitor visually presents the data to the user or users.

Cathode ray tubes (CRTs) have been widely used as computer monitors. Increasingly, liquid crystal display (LCD) screens are becoming increasingly popular as they are smaller, lighter, and consume less electricity. There is a trend toward smaller and lighter monitors, i.e., portable monitors especially for applications such as laptop and notebook computers.

In the prior art, the computer monitor is a fixed device that plugs into a computer via cable. All displayed data travels over the cable to the monitor. Likewise, other computer components, including the mouse, keyboard, etc., plug directly into the computer's main housing.

The computer monitor according to the prior art has several drawbacks. The cords are usually relatively short. This may lead to a need for an extension cable in some situations. As a result, the components are relatively fixed to the computer main housing. The user cannot move the monitor, keyboard, mouse, speakers, etc., very much unless the user purchases a laptop or notebook computer, for example. It would be highly convenient, however, if the display device and other components were not tied to the computer main housing, but could be moved around in relation to it.

Therefore, there remains a need in the art for improvements in computer systems.

### SUMMARY OF THE INVENTION

A computer system comprises a computer wireless transceiver capable of relaying wireless communications to and from a computer main unit, a computer display device, and a monitor wireless transceiver connected to the computer display device. The monitor wireless transceiver conducts wireless communications with the computer wireless transceiver. The monitor wireless transceiver and the computer display device comprise a wireless computer monitor that receives data from and transmits data to the computer main unit in a wireless manner.

### BRIEF DESCRIPTION OF THE DRAWINGS

FIG. 1 shows a computer system according to one embodiment of the invention;

FIG. 2 is a schematic of a wireless computer monitor according to one embodiment of the invention; and

FIG. 3 is a flowchart of a method of wirelessly linking a computer and a computer display device according to one embodiment of the invention.

### DETAILED DESCRIPTION

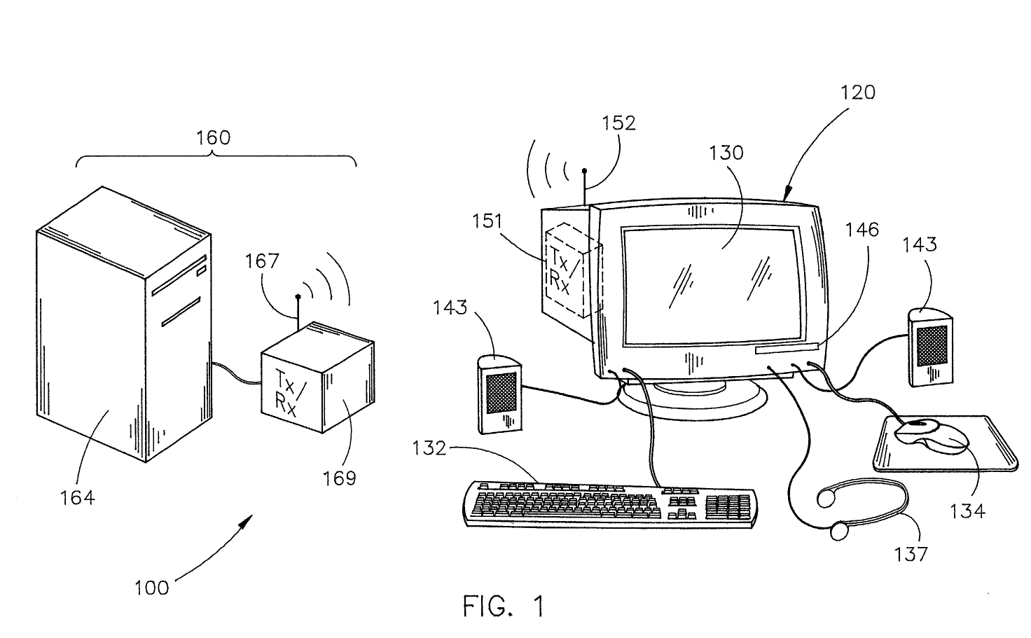

FIG. 1 shows a computer system 100 according to one embodiment of the invention. The computer system 100 includes a computer main unit 160 and wireless computer monitor 120. According to the invention, the wireless computer monitor 120 is not physically linked to the computer main unit 160, but instead communicates with the computer main unit 160 in a wireless manner. The wireless computer monitor 120 receives display data and audio data and presents it to the user. The wireless computer monitor 120 also receives user inputs and relays them to the computer.

The wireless computer monitor 120 of the invention may be used with any manner of personal computer (PC), workstation, server, and even laptop and notebook computers. For laptop and notebook computer use, the wireless computer monitor 120 may convert such a computer device into essentially a docking station.

The computer main unit 160 includes a computer body 164 and a computer wireless transceiver 169 and associated antenna 167. The computer wireless transceiver 169 is shown as an external device that is connected to the computer body 164. It should be understood that alternatively the transceiver 169 may be internal to the computer body 164. The transceiver 169 may be any manner of wireless transceiver and may communicate using radio frequency (RF) signals, infrared (IR) signals, etc. The transceiver 169 of the computer main unit 160 may comprise an external device that connects to the existing mouse, keyboard, sound card, and video cards within the computer body 164. Therefore, the user may not have to replace or discard existing cards. Through the use of the transceiver 169, the wireless computer monitor 120 appears to the computer body 164 to be a typical peripheral device such as a monitor, keyboard, mouse, etc. Consequently, there may be no need for special drivers within the computer body 164.

The wireless computer monitor 120 includes a computer monitor device 130 and a monitor wireless transceiver 151 and associated antenna 152. The monitor wireless transceiver 151 is shown as an internal device. It should be understood that alternatively the monitor wireless transceiver 151 may be an external device that is connected to the computer monitor device 130. If the monitor wireless transceiver 151 is an external device, then the keyboard, pointing devices, headphones, speakers, etc., may plug directly into the monitor wireless transceiver 151.

The computer monitor device 130 may be any type of computer monitor device, including a cathode ray tube (CRT) screen, a liquid crystal display (LCD) screen, a plasma gas discharge display screen, etc. In addition, the wireless computer monitor 120 may include any manner of connectable input and output devices, including a keyboard 132, some manner of pointing device 134 (such as a mouse, joystick, roller ball or track ball, etc.), audio speakers 143, headphones 137, etc. In addition, the wireless computer monitor 130 may include a monitor control panel 146 that includes controls for setting display characteristics of the computer monitor device 130.

In an optional embodiment, the wireless computer monitor 120 may also include an extendable input/output (EI/O) port (not shown), wherein other computer devices may be plugged into the wireless computer monitor 120, such as, for example, disk drives.

In operation, data is transferred wirelessly between the computer main unit 160 and the wireless computer monitor 120. As previously mentioned, this may be through RF communication, IR communication, etc. The download speeds from the computer main unit 160 to the wireless computer monitor 120 may be higher than upload speeds in the other direction. This is because more data will likely flow to the wireless computer monitor 120, including audio, text, graphics, etc. Data generated from the keyboard 132 and pointing device 134 may be much smaller.

However, there will need to be communication in both directions (i.e., full duplex communications). Full duplex communication may be required if captured audio is to be sent from the wireless computer monitor 120 to the computer main unit 160. The transfer of digital audio information may occur if the wireless computer monitor 120 includes a microphone jack and microphone (not shown). This may be desirable in cases where the user desires to capture a voice or other sound to the computer body 164.

The wireless computer monitor 120 according to the invention therefore may be remote from the computer main unit 160. The wireless computer monitor 120 may be mobile or may be in a conveniently located and movable position. The user will not need to worry about cord lengths or the distance from the wireless computer monitor 120 to the computer body 164. For example, the wireless computer monitor 120 and associated devices could be on a rollable appliance, such as a desk or a cart.

In an optional embodiment, both the computer body 164 and the wireless computer monitor 120 may include unique addresses that are included in some or all of the wireless communications. Therefore, multiple display devices may be used in a computer environment. This would allow the use of multiple monitors (with or without keyboards, etc.) that could be set to the same address as one base computer unit. Multiple monitors may be wirelessly connected to a single computer for large classes, for demonstrations, automation, etc.

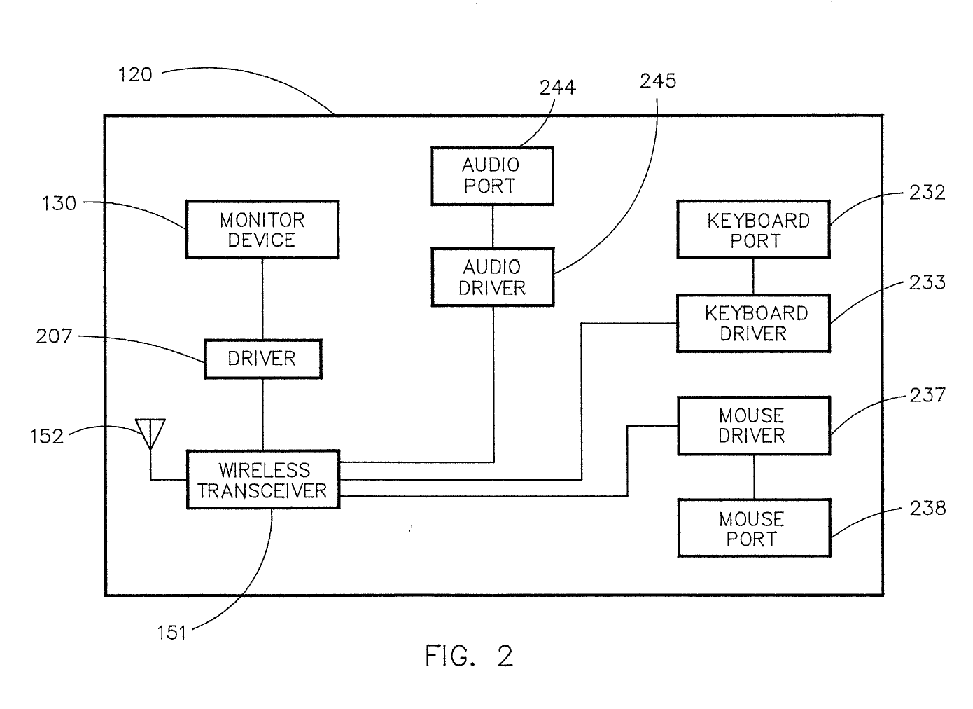

FIG. 2 is a schematic of the wireless computer monitor 120 according to one embodiment of the invention. The wireless computer monitor 120 may include the monitor wireless transceiver 151 and associated antenna 152, as previously discussed. In addition, it may include a computer monitor device 130, such as a CRT screen, LCD screen, LED screen, etc., and an optional display driver 207. The display driver 207 may be included if there is a need to translate data between the monitor wireless transceiver 151 and the computer monitor device 130. The wireless computer monitor 120 also includes an audio port 244 and associated audio driver 245, a keyboard port 232 and associated keyboard driver 233, and a mouse port 238 and associated mouse driver 237. It should be understood that the various drivers may be included if the data transmitted or received by the monitor wireless transceiver 151 requires some manner of data translation, buffering, etc.

The audio port 244 may be a single port or may include multiple ports, such as, for example, an output port for speakers, an output port for headphones, a port for a microphone input, a port for a CD line-in input, etc.

The keyboard port 232 interfaces between the keyboard 132 and the wireless computer monitor 120. Therefore, the keyboard 132 may be plugged into the wireless computer monitor 120 (see FIG. 1). The wireless computer monitor 120 therefore relays keyboard inputs to the computer body 164.

Likewise, the mouse port 238 receives inputs from a mouse 134 (or other pointing device). It should be understood that the mouse port 238 may be used for any manner of pointing device, such as mouse, joystick, etc., and therefore may also constitute a game port.

It should be understood that the monitor wireless transceiver 151 may be an RF transceiver, an IR transceiver, etc., as previously discussed. If the monitor wireless transceiver 151 communicates using radio waves, then the antenna 152 is a radio antenna. If the monitor wireless transceiver 151 is an infrared device, then the antenna 152 may comprise a photo diode for generating IR light pulses and a photo detector for receiving IR light pulses, instead of a radio antenna.

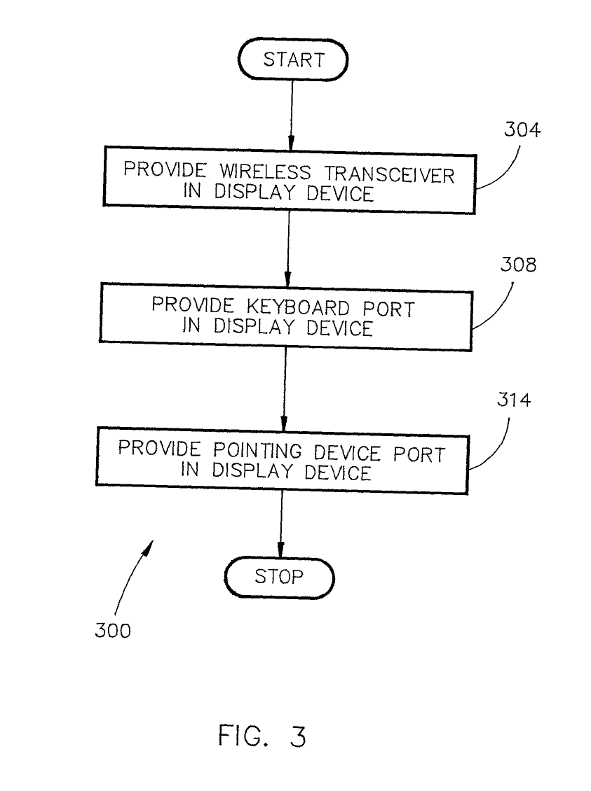

FIG. 3 is a flowchart 300 of a method of wirelessly linking a computer main unit and a computer display device according to one embodiment of the invention. In step 304, a monitor wireless transceiver 151 is provided in the display device (i.e., in the wireless computer monitor 120). As previously discussed, the monitor wireless transceiver 151 may be any type of wireless transceiver.

In step 308, a keyboard port is provided in the wireless computer monitor 120. The keyboard port enables a keyboard 132 to be attached to the wireless computer monitor 120, which in turn provides the keyboard inputs to the computer body 164.

In step 314, a pointing device port is provided in the wireless computer monitor 120. As previously discussed, this may be any type of mouse, joystick, track ball, roller ball, etc. In addition, the method optionally may include providing an audio port in the wireless computer monitor 120, as previously discussed.

The wireless computer monitor 120 of the invention differs from the prior art in that display data is provided in a wireless manner to the wireless computer monitor 120. Further, keyboard inputs may be received in the wireless computer monitor 120 and provided to the computer body 164 in a wireless manner, and the pointing device input may also be received in the wireless computer monitor 120 and passed and relayed to the computer body 164. This may additionally include relaying of audio data between the wireless computer monitor 120 and the computer body 164. Therefore, all user interactive components, such as the display, keyboard, pointing device, speaker, audio devices, etc., are not physically linked to the computer body 164 and may be portable with respect to the computer body 164.

The wireless computer monitor 120 of the invention provides several benefits. It provides mobility to the display, keyboard, mouse, and audio devices. These components are therefore unlinked from the computer body 164 in order to provide true mobility to the user. The wireless computer monitor 120 allows a user to position the display where it is convenient and where it is best viewed. For example, the wireless computer monitor 120 may be positioned where it may be convenient on a computer desk or bench instead of being positioned in order to allow the cable to extend between the monitor and the computer. Therefore, the wireless computer monitor 120 allows computer components to be optimally positioned on a desk, bench or other work space without constraints of cable lengths. In addition, it allows them to be mobile and repositioned at the user's convenience without concern for cables. Moreover, the invention enables the use of multiple computer monitors with a single computer.

We claim:

1. A computer system, comprising:
a computer wireless transceiver performing wireless communications and capable of being connected to and relaying said wireless communications to and from a computer main unit;
a monitor wireless transceiver performing wireless communications; and
a computer display device connected to said monitor wireless transceiver and transmitting communication signals to and receiving communication signals from said monitor wireless transceiver;
wherein said monitor wireless transceiver and said computer display device comprise a wireless computer monitor that is capable of receiving data from and transmitting data to said computer main unit in a wireless manner through said monitor wireless transceiver and said computer wireless transceiver.

2. The system of claim 1, wherein said computer wireless transceiver and said monitor wireless transceiver employ radio frequency (RF) communications.

3. The system of claim 1, wherein said computer wireless transceiver and said monitor wireless transceiver employ infrared (IR) communications.

4. The system of claim 1, wherein said wireless computer monitor further comprises a display driver connected between said computer display device and said monitor wireless transceiver.

5. The system of claim 1, wherein said wireless computer monitor further comprises:
an audio port capable of connecting one or more audio devices to said wireless computer monitor; and
an audio driver;
wherein said audio port and said audio driver are connected to said monitor wireless transceiver and are capable of relaying data between said computer main unit and said one or more audio devices in a wireless manner.

6. The system of claim 5, wherein said audio port and said audio driver relay data to and from said one or more audio devices.

7. The system of claim 1, wherein said wireless computer monitor further comprises:
a keyboard port capable of connecting a keyboard to said wireless computer monitor; and
a keyboard driver;
wherein said keyboard port and said keyboard driver are connected to said monitor wireless transceiver and are capable of relaying data from said keyboard to said computer main unit in a wireless manner.

8. The system of claim 1, wherein said wireless computer monitor further comprises:
a pointing device port capable of connecting one or more pointing devices to said wireless computer monitor; and
a pointing device driver;
wherein said pointing device port and said pointing device driver are connected to said monitor wireless transceiver and are capable of relaying data from said one or more pointing devices to said computer main unit in a wireless manner.

9. A computer system, comprising:
a computer wireless transceiver performing wireless communications and capable of being connected to and relaying said wireless communications to and from a computer main unit;
a wireless computer monitor, said wireless computer monitor comprising;
a monitor wireless transceiver performing wireless communications;
a computer display device connected to said monitor wireless transceiver, wherein said wireless computer monitor is capable of receiving data from and transmitting data to said computer main unit in a wireless manner through said monitor wireless transceiver and said computer wireless transceiver;
a keyboard port and a keyboard driver connected to said monitor wireless transceiver and capable of relaying data from said keyboard to said computer main unit in a wireless manner; and
a pointing device port and a pointing device driver connected to said monitor wireless transceiver and capable of relaying data from said one or more pointing devices to said computer main unit in a wireless manner.

10. The system of claim 9, wherein said computer wireless transceiver and said monitor wireless transceiver employ radio frequency (RF) communications.

11. The system of claim 9, wherein said computer wireless transceiver and said monitor wireless transceiver employ infrared (IR) communications.

12. The system of claim 9, wherein said wireless computer monitor further comprises:
an audio port capable of connecting one or more audio devices to said wireless computer monitor; and
an audio driver;
wherein said audio port and said audio driver are capable of relaying data between said computer main unit and said one or more audio devices in a wireless manner.

13. The system of claim 12, wherein said audio port and said audio driver relay data both to and from said one or more audio devices.

14. The system of claim 9, wherein said wireless computer monitor further comprises a display driver connected between said computer display device and said monitor wireless transceiver.

15. A method of wirelessly linking a computer main unit and a computer display device, comprising the steps of:
providing a computer wireless transceiver connected to said computer main unit and capable of transmitting and receiving wireless communications; and
providing a monitor wireless transceiver connected to said computer display device and capable of transmitting and receiving wireless communications;
wherein said monitor wireless transceiver receives data from said computer main unit in a wireless manner and relays said data to said computer display device.

16. The method of claim 15, further comprising the step of providing a keyboard port and a keyboard driver in said computer display device, with said keyboard port and said keyboard driver relaying data from said keyboard to said computer main unit in a wireless manner.

17. The method of claim 15, further comprising the step of providing a pointing device port and a pointing device driver in said computer display device, with said pointing device port and said pointing device driver relaying data from a pointing device to said computer main unit in a wireless manner.

18. The method of claim 15, further comprising the step of providing an audio port and an audio driver in said computer display device, with said audio port and said audio driver relaying data between one or more connected audio devices and said computer main unit in a wireless manner.

19. The method of claim 15, wherein the steps of providing a computer wireless transceiver and providing a monitor wireless transceiver further comprise providing radio frequency (RF) transceivers.

20. The method of claim 15, wherein the steps of providing a computer wireless transceiver and providing a monitor wireless transceiver further comprise providing infrared (IR) transceivers.
